(19) United States
(12) Patent Application Publication
(10) Pub. No.: US 2011/0247891 A1
(43) Pub. Date: Oct. 13, 2011

(54) STEERING SYSTEM HAVING NOISE-REDUCING COMPONENTS MADE OF COMPOSITE MATERIAL

(75) Inventors: Martin Meyer, Alstattent (CH); Christoph Klukowski, Gamprin (LI)

(73) Assignee: THYSSENKRUPP PRESTA AG, ESCHEN (LI)

(21) Appl. No.: 13/140,533

(22) PCT Filed: Nov. 5, 2009
(86) PCT No.: PCT/EP09/07942

§ 371 Date: Jun. 17, 2011

(30) Foreign Application Priority Data
Dec. 19, 2008 (DE) 10 2008 063 712.2

(51) Int. Cl. B62D 5/04

(52) U.S. Cl. 180/443

(57) ABSTRACT

The invention relates to a steering system with a steering wheel, an upper steering shaft, a lower steering shaft and a steering gear, having a servo drive or superposition drive, and wherein at least one housing part is manufactured from sheet metal implemented as a composite material, wherein the composite material has a first metal layer and a second metal layer, between which an insulating layer is arranged made of a viscoelastic material or an elastomer.

The present invention relates to a steering system having the features of the preamble to claim 1.

Steering systems, and in particular steering systems with electromotive power assistance, contain a large number of possible sources of noise. These are, for example, the mechanical effects of the steered wheels, which are registered in the steering mechanism via track rods. Furthermore, the mechanical engagement between the rotatable part of the steering mechanism and the toothed rack or another connecting link to the track rods is a source of noise. An electric servo drive with a reduction gear is a further potential source of noise. Noises of this kind attract attention in a particularly negative way with motor vehicles whose interior is particularly well insulated and which, therefore, are quiet when running. With the expected increase in hybrid vehicles and vehicles with electric drives, it can be anticipated that the noise level inside will once more drop owing to the partial or total disappearance of engine noises from an internal combustion engine.

Against this background, it is intended to absorb and/or deaden other sources of noise. This also relates to the steering, and particularly to the electromotive power steering system, because employing the electromotive drive produces a noise spectrum which is noticeable to the motorist.

A common noise suppression measure within the scope of steering systems makes provision for the steering column and particularly the steering gear to be fitted in rubber-metal bushes. This arrangement prevents noises from being transferred from the steering to the body. However, in so doing, neither the generation of noise itself nor transfer by means of air-borne noise is reduced. Parts of the steering are also filled with foam or provided with insulating material. These measures are elaborate and result in increased weight and increased costs.

Hence, it is the object of the present invention to create a steering system the noise generation of which in operation, with respect to the motor vehicle interior, is deadened in a simple way.

This object is achieved by a steering system having the features of claim 1. Preferred embodiments of the invention are presented in the features of the dependent claims.

Exemplary embodiments of the present invention are described in more detail below with the aid of the drawing.

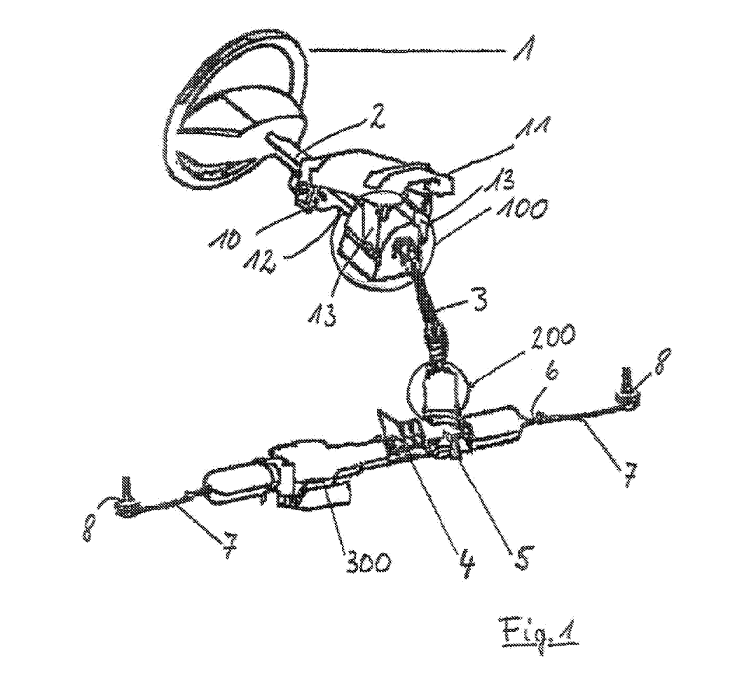

FIG. 1: shows an electromotively-assisted steering system with an adjustable steering column;

FIG. 2: shows a cross-section through an electric servo drive perpendicular to the steering column;

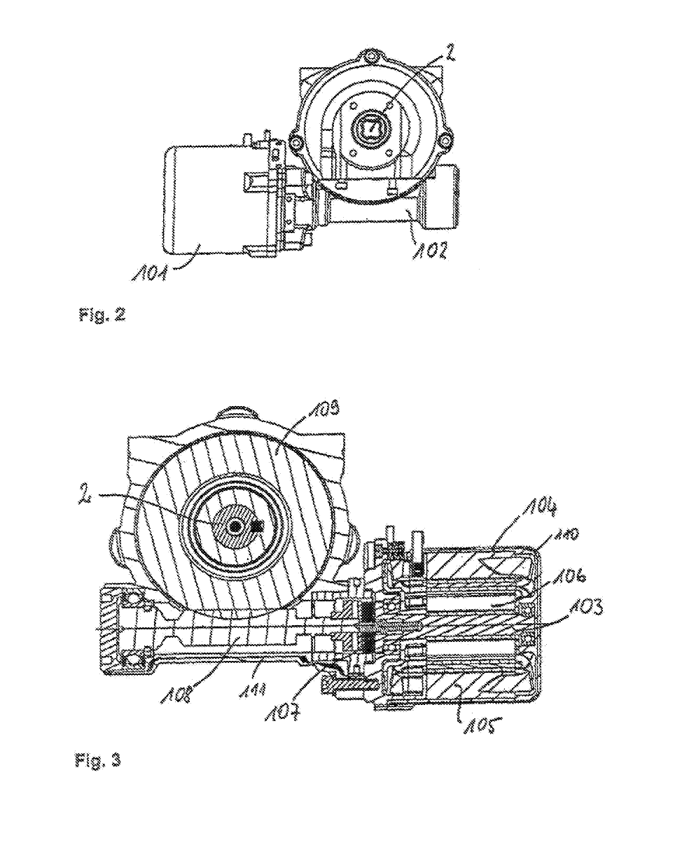

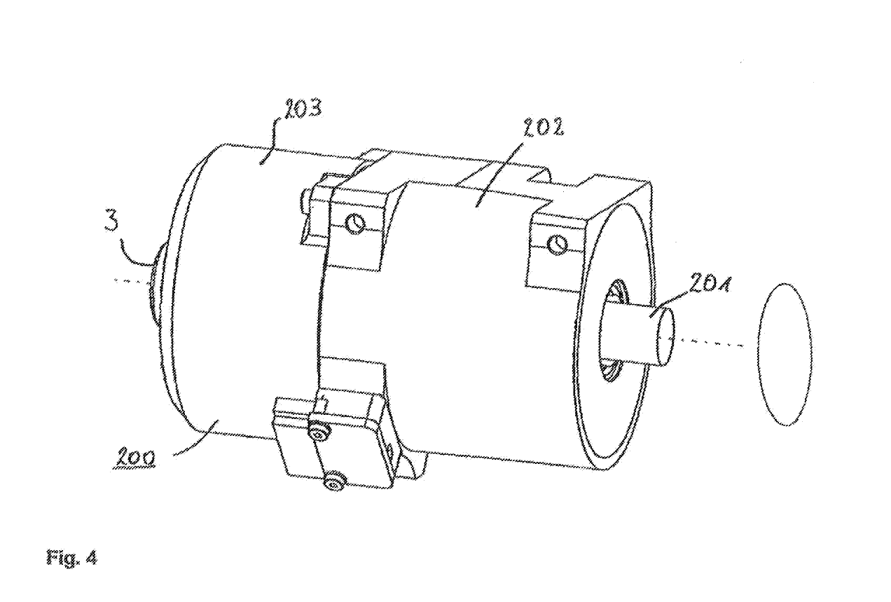

FIG. 3: shows the drive from FIG. 2 in a longitudinal section through the electric motor;

FIG. 4: shows an electric servo motor with internal reduction gear for use in an electric steering system;

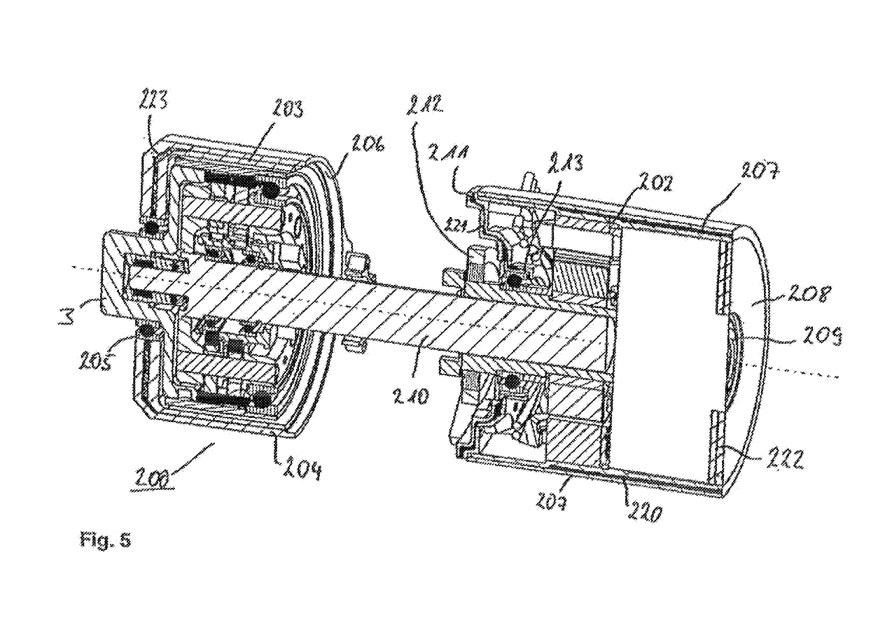

FIG. 5: shows the electric motor from FIG. 4 in a longitudinal section with separate motor and gear parts;

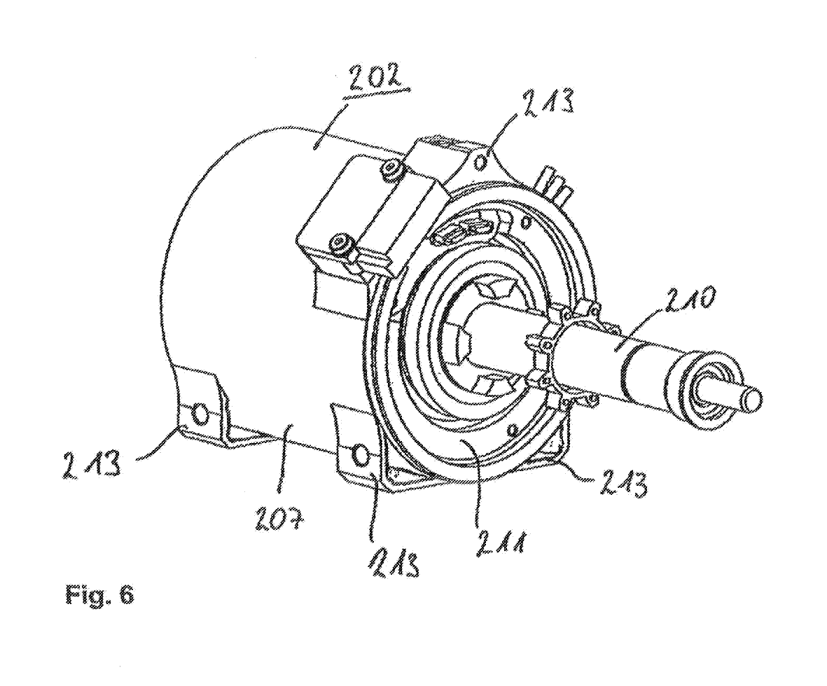

FIG. 6: shows the electric motor from FIG. 5 in a perspective illustration;

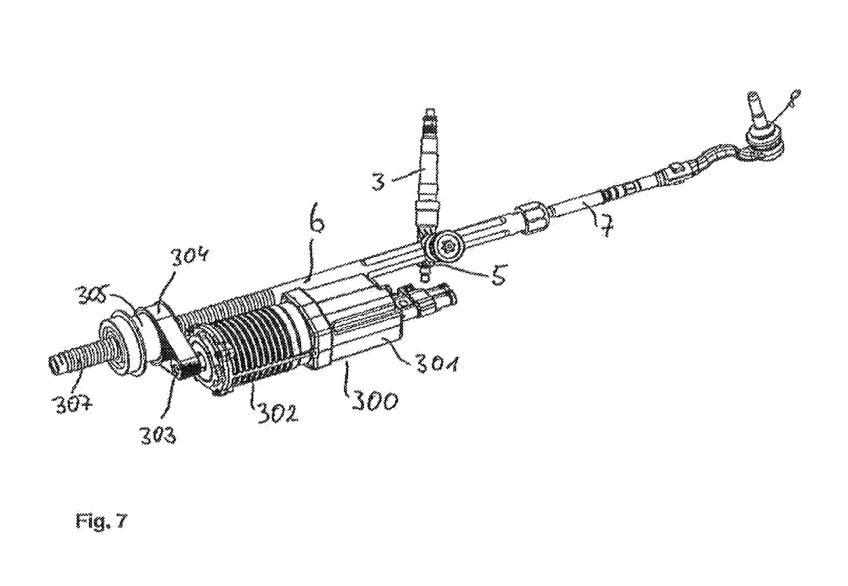

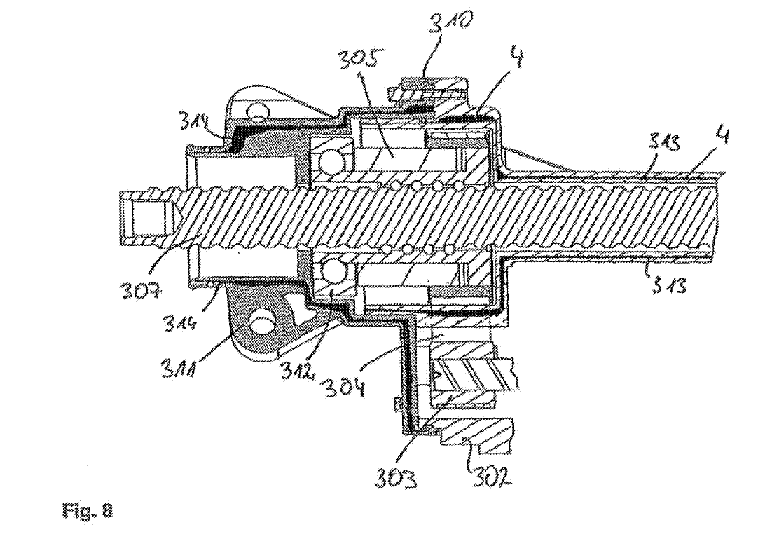

FIG. 7: shows an electrically assisted steering gear with a servo motor arranged parallel to the toothed rack;

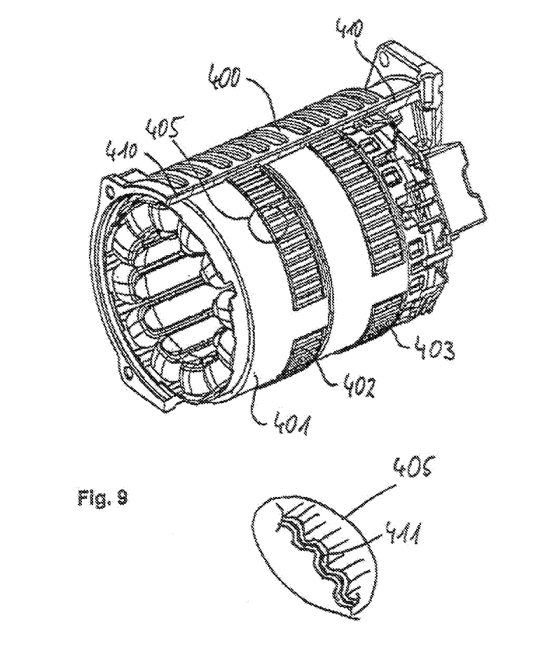

FIG. 8: shows a longitudinal section through a recirculating ball gear of an electric power steering system;

FIG. 9: shows a perspective sectional illustration of the electric motor from FIG. 7;

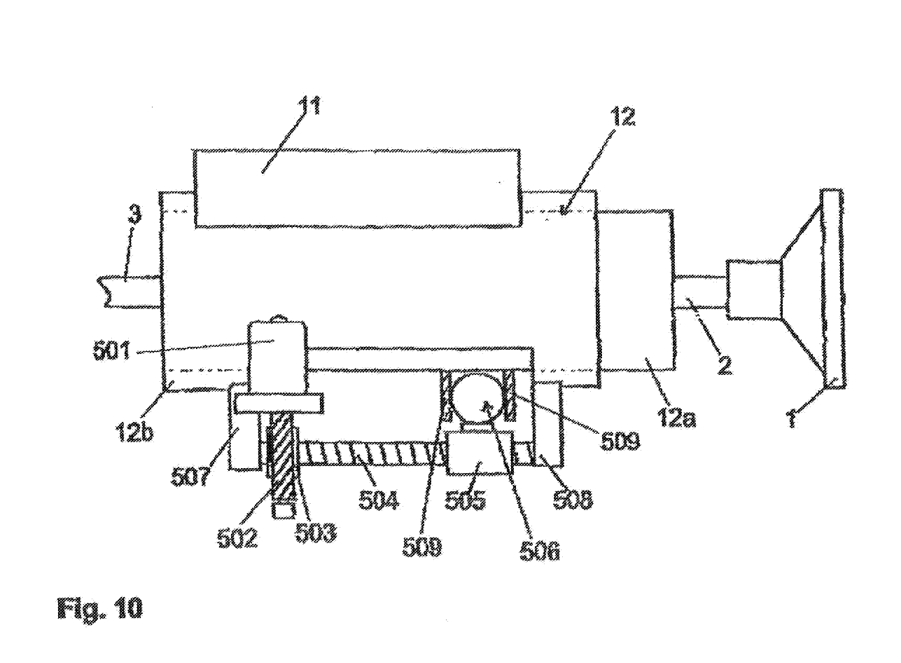

FIG. 10: shows an electrically adjustable steering column with adjusting motor according to the invention and

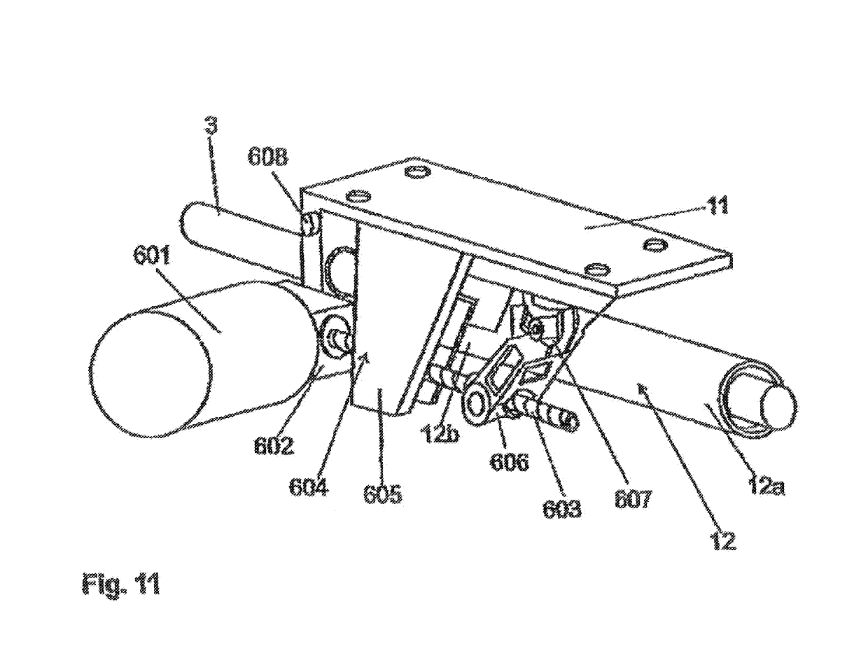

FIG. 11: shows a further example of an electrically adjustable steering column with electric motor according to the invention and holding plate.

A steering system is represented in FIG. 1, in which a steering wheel 1 is connected to a steering gear 4 via an upper steering shaft 2 and a lower steering shaft 3. The steering gear 4 is designed as a toothed rack steering mechanism, in which a pinion of the lower steering shaft 3 meshes in an engagement area 5 with a toothed rack 6 which is longitudinally displaceable in the housing 4. The toothed rack 6 is, in turn, connected to two track rods 7 which operate the steerable wheels of a vehicle front axle via ball heads 8.

The steering system is provided with an adjustable steering column 10 which is mounted in a console 11 with respect to the vehicle body. The steering system is, in this respect, notional as here three possible positions of a servo drive, or of a superposition gear in superposition steering mechanisms, are illustrated. The first position 100 shows a possible servo drive or a superposition gear in the area of the upper steering shaft 2. The reference number 200 shows an electromotive auxiliary drive which is assigned to the pinion engagement area 5 on the steering gear 4. Finally, the reference number 300 shows a position at which an electric auxiliary drive can be arranged with a direct connection to the toothed rack, for example as a hollow shaft motor which is coaxially arranged in relation to the toothed rack, or as a motor which is laterally spaced apart and which drives the toothed rack via a synchronous belt drive. In both cases, a recirculating ball gear is advantageous for converting the rotary movement into a linear movement.

FIG. 2 shows an electric motor 101 with a worm drive 102 which can act on the upper steering shaft 2 or on the lower steering shaft 3.

FIG. 3 shows the electric motor from FIG. 2 in a longitudinal section along a motor shaft 103. The motor has a pot-shaped housing 104, in which the stator assembly 105 is arranged. A rotor 106 is connected in a torque-proof manner to the ball bearing mounted motor shaft 103. An elastic coupling 107 drives a likewise ball bearing mounted worm shaft 108. The worm shaft 108 meshes with a worm wheel 109 which is arranged in a torque-proof manner on the upper steering shaft 2. The current feed of the electric motor 101 consequently leads to a rotation of the upper steering shaft 2 in the one or the other direction.

FIG. 4 shows an electric servo motor 200 with an attached gear in a perspective illustration. The electric motor 200 is provided as a unit having a coaxial input shaft 3 and an output shaft 201, wherein the output shaft 201 can be formed connected or as one piece with the pinion in the area 5 from FIG. 1. The motor 200 has an electric motor part 202 and a gear part 203, which are connected to a structural unit. The auxiliary drive is provided with the position identified by 200 for integration into FIG. 1.

FIG. 5 shows the drive from FIG. 4, pulled apart in a longitudinal section. The gear part 203 is mounted in an outer housing 204 which on the side turned away from the motor 202 has a front face with a coaxial bore hole for a ball bearing 205 of the lower steering shaft 3. A cylindrical area is attached to the front face, the cylindrical area being equipped with a groove 206 for fitting the electric motor 202. The electric motor 202, in turn, has an essentially cylindrical sleeve-shaped housing 207 which on the side turned away from the gear 203 is closed by a housing cover 208. The housing cover 208 holds a centrally arranged ball bearing 209, for the shaft 210 connected to the steering pinion. On the end facing the gear 203, the cylindrical housing 207 is closed with a cover 211 which can be formed as a deep-drawn part and which has a shape which, on the one hand, is compatible with the groove 206 and which, on the other hand, in the interior space allows for a coupling 212 and a further rolling bearing 213.

FIG. 6 shows the motor part 202 in another perspective illustration. The motor housing 207 has holders 213 which are provided for attaching the electric motor 203 to the steering gear 4 or to a chassis of a motor vehicle. The holders 213 can be designed as sheet metal formed parts in the form of brackets which are adhesively bonded or welded to the motor housing 207.

FIG. 7 illustrates the arrangement of an electric servo drive 300 in a position arranged parallel to the toothed rack 4. The electric motor 300 has a motor part 301 and a gear part 302, the electric and mechanical components of which are also arranged in housings on sheet metal formed parts. The servo drive 300 drives a recirculating ball 305 via a pinion 303 and a synchronous belt 304, the recirculating ball 305, in turn, via a ball screw 307 displacing the toothed rack 6 in the steering mechanism housing, which is not illustrated, in the longitudinal direction of the toothed rack.

The recirculating ball 305 is illustrated in more detail in a longitudinal section in FIG. 8. The reference numbers specify the components already described in connection with FIG. 7. In this illustration, the steering mechanism housing 4 is illustrated which is designed as a thin-walled component and which has a flange 310 on the face side for attaching a housing cover 311. The housing cover 311 is, at the same time, designed as a bearing seat for a rolling bearing 312 of the ball screw drive 305. The gear housing 302 is, on the one hand, attached to the housing cover 311 and, on the other hand, (not illustrated) to the steering mechanism housing 4.

Finally, FIG. 9 shows, in a perspective partial section, an electric motor housing 400, into which a stator assembly 401 is inserted. Two rings 402 and 403 are provided to fix the stator assembly 401 in the motor housing 400. The rings have a corrugated cross-section in the circumferential direction. When the stator assembly 401 is inserted into the housing 400, the radially outer lying surface areas of the rings 402 and 403 abut on the inner wall of the motor housing 400, while the radially inner lying areas of the rings 402 and 403 abut on the stator assembly 401. The outer diameter of the stator assembly 401 is smaller than the inner diameter of the motor housing 400, so that no direct mechanical contact exists between the housing 400 and the stator assembly 401.

A detail 405 illustrates the cross-section through the ring 402 in FIG. 9.

In FIG. 10, an electrically adjustable steering column is illustrated, in which the steering wheel can be displaced by means of an adjusting motor 501 in its position along the longitudinal axis of the steering shaft 2. For this purpose, the electromotive power of the electric motor 501 is transmitted via a gear connection consisting of a worm gear 502 and a toothed wheel 503 to a screw shaft 504. This screw movement is converted via a threaded nut 505 into a translatory movement which is conveyed to the upper jacket tube 12a via a driver unit 506. By the support of the electric motor on the lower jacket unit 12b on the body side, a lengthwise adjustment is thereby made possible between the upper jacket unit 12a and the lower jacket unit 12b. The steering shaft 2, to which the steering wheel 1 is attached, is pivot-mounted to the upper jacket unit 12a.

According to the embodiment according to the invention, the housing of the electric motor 501 comprises a composite material which consists of multilayered sandwich-like sheet metal, in which a layer consisting of an elastomer or a viscoelastic material is provided between two metal layers, as has already been explained with the other exemplary embodiments of the invention. Furthermore, the support attachments 507 and 508 are advantageously also produced from this composite material. Noise insulation and/or noise suppression can be advantageously further increased by the holder 509 for the driver device 506 also being produced from this composite material. In this way, all the vibrations transmitted from the electric motor to the lower jacket unit 12a, which is firmly attached to the body, and to the upper, movable jacket unit 12a can be deadened or absorbed.

The application can also be implemented on vertically adjustable steering columns, if, for example, the lower jacket unit 12b is pivotably attached in a support device (not illustrated here) with respect to the body.

In FIG. 11, a further embodiment of the invention for an electrically lengthwise-adjustable steering column is illustrated. Here too, comparable with the solution corresponding to FIG. 10, an upper jacket unit 12a, designed here as a tube, with respect to a lower jacket unit 12b, which is also designed as a tube, is displaced in the longitudinal direction of the steering shaft 2 by the electric adjusting mechanism. The electric adjusting mechanism, which is supported on the body, consists of an electric motor 601 which conveys its rotary movement via a gear 602 to the rotary movement of an adjusting spindle 603. The adjusting spindle 603 is supported in a support 604 which comprises a holding plate 605. The rotary movement is converted into a translatory movement via a threaded nut 606. The translatory movement is conveyed to the jacket unit via a coupling element 607. Here, it is conceivable and possible, by means of corresponding kinematics, simultaneously with the displacement of the steering shaft 12 in the longitudinal direction, to also carry out a rotation, with respect to this longitudinal direction, about the centre of rotation 608. In the prior art, an array of different kinds of such electrically controllable adjusting systems for steering columns are known, so that detailed design features of such devices can be omitted here.

According to the invention, provision is made for individual or all of the following elements to be produced from the composite material as already described:

The housing of the electric motor 601, the holding plate 605 of the support device 604 and the connection elements for attaching the driver 607 to the jacket unit. As has already been generally explained, it is, in addition, preferred if the holding console 11, to which the steering column is attached in the vehicle, is also produced from this composite material.

With the components described, in this respect, which are essentially known from the prior art, there are numerous sources of noise which during operation produce structure-borne noise and air-borne noise.

According to the invention, these sources of noise are absorbed and/or deadened by using a composite material at various places. The composite material is multilayered sandwich-like sheet metal, in which a layer consisting of an elastomer or a viscoelastic material is provided between two metal layers. The two metal top layers can be manufactured from steel or a light metal, preferably with wall thicknesses in the range from 0.3 to 1 mm. The insulating layer in between can likewise be in the range from 0.3 to 1 mm thick. This composite material can be plate-like or strip-shaped and can be essentially processed like conventional sheet steel. It can, in particular, also be punched, bored and deep-drawn. This sheet metal is preferably connected to other mechanical components by adhesive bonding.

Where the sheet metal is used for noise insulation in the components in FIGS. 1 to 11 is specified below.

In FIG. 1, the console 11 of the steering column 10 can be manufactured from the above described composite material, for example in a deep-drawing process. The part can also be pressed. The upper steering shaft 2 moves in a jacket tube 12 which can be manufactured from the composite sheet metal. In addition, the steering column 10 hangs on brackets 13 which can also be manufactured from the composite material. The components described further below can also be made to absorb and/or deaden noise by using the composite material.

The housing for the servo motor 200 can be deep drawn or rolled as a pot. The housing of the servo motor 300 can be produced from the composite material. Finally, the whole steering mechanism housing 4 can also be manufactured from the composite material. This is explained in more detail below.

In FIGS. 2 and 3, the pot-shaped motor housing 104 is produced from the composite material, which is illustrated by the polymer layer 110. The same applies for the housing 111, in which the worm shaft 108 is mounted.

With the exemplary embodiment from FIGS. 4, 5 and 6, particularly the sleeve-shaped motor house 207 can be manufactured from the composite material, so that the noise generation from the motor outwards is absorbed and/or deadened. For this purpose, the housing 207 has a polymer layer or viscoelastic layer 220 embedded in the sheet metal jacket. In a similar way, the cover 211 is manufactured from the composite material. A polymer layer 221 is inserted there. The cover 208 on the face side can likewise be manufactured from the composite material described to complete the noise insulation. Here, the insulating layer is identified by 222.

The gear part 203 in FIG. 5 is provided with a pot-shaped housing consisting of noise-absorbing and/or deadening composite material. Here, the composite material has a viscoelastic or elastomeric intermediate layer 223.

Deadening of structure-borne noise, which is required when the servo drive from FIGS. 4 to 6 is in operation, can be accomplished via the holders 213. The holders 213 are formed as brackets on the underside in FIG. 6 and are manufactured from the composite material. The brackets are preferably adhesively bonded to the housing 202 of the electric motor. The above arranged bracket 213 can be manufactured as a sheet metal formed part. With this arrangement, the composite material effectively suppresses the structure-borne noise which could be transmitted from the servo motor 202 to the supporting structural part, i.e. the chassis or the steering gear 4.

If the holders 213 from FIG. 6 or the brackets 13 from FIG. 1 are screwed to the body in an appropriate manner, i.e. without the noise-generating component making direct, metal contact with the supporting structure, then rubber bearings, rubber-metal bushes and the like can be dispensed with. Mounting is thereby simpler, cheaper and more rigid.

Further examples for the noise-absorbing and/or noise-deadening embodiment of steering systems according to the invention are illustrated in FIGS. 7 to 9. In FIG. 7, the housing of the electric motor 301, the gear housing 302 and/or the tubular ball nut 305 can be manufactured from the composite material. In particular, with toothed rack steering mechanisms a section is provided, between the area of engagement 5 of the pinion with the toothed rack 6, usually a tubular steering mechanism housing 4, which is manufactured from the composite material. The housing cover 311 can also have the viscoelastic insulating layer. Here, the layers are identified by 313 and 314.

Finally, in FIG. 9 provision is made for the housing 400 of the illustrated electric motor to be manufactured from the composite material. An insulating layer 410 is provided in the sleeve-shaped housing for this purpose, which acoustically separates the inner housing wall and the outer housing wall. The tolerance rings 405, which are manufactured from composite material having a viscoelastic insulating layer 411 in between, provide a further decoupling possibility.

Finally, with the motor from FIG. 9 provision is made for the stator laminations to be manufactured from the composite material. In a similar way, the core laminations of the rotor, which is not illustrated, can also be produced from the composite material.

The composite material, which was described at the outset, can be processed in the appropriate manner, so that the described components can be manufactured. It can be formed, whereby care has to be taken that the intermediate layer is not displaced. The material can be bent, stretched, bored and punched. When forming, the material can be directly formed in such a way that a suitable bearing seat is formed, such as for example in FIG. 8 for the rolling bearing 312 or in FIG. 5 for the rolling bearings 205 and 209. An advantage in using composite material for the various components of a steering system is also that other noise insulation measures, such as filling with foam or using additional seals, can be dispensed with. Thus, there is additionally a reduction in weight. The intrinsically heavier cast metal housings, which have been used up to now in steering systems, despite the technological possibility, have not or have only rarely up to now been replaced by sheet metal housings, because a higher noise emission can be expected with sheet metal housings. The use of the composite material removes this disadvantage, so that now steering mechanism housings or parts thereof can also be manufactured from the sheet-like composite material and cast metal housings can be dispensed with.

Care has to be taken with the design of the components to be manufactured from composite material that the composite material as far as possible encloses the entire noise source, thus, for example, an electric motor, a hydraulic pump a bearing shell or a fast rotating toothed wheel, so that as far as possible there is no purely metal connection with the rest of the components and surrounding body parts.

In a special further embodiment of the invention, a layer consisting of an electroactive polymer is used as an intermediate layer between the two metal layers of the composite material. This layer reacts to electric and/or magnetic fields and is very particularly suitable for enclosing electric motors or for the use of core laminations for stators and rotors in the electric motor. The frequency behaviour can be specifically controlled by means of a corresponding design using layer thickness and/or proportion of electroactive elements in the polymer layer. In this way, it is possible to obtain a particularly good suppression and/or insulation function for certain critical frequencies.

1. A steering system for a motor vehicle comprising a steering wheel, an upper steering shaft, a lower steering shaft and an electric drive, wherein the upper steering shaft is held pivot-mounted in a jacket unit and the electric drive can be directly or indirectly connected to a vehicle body, wherein at least one housing part and/or one holding part is/are manufactured from sheet metal implemented as a composite material, wherein the composite material has a first metal layer and a second metal layer, between which a layer is arranged made of a viscoelastic material or an elastomer.

2. The steering system according to claim 1, wherein the steering column has a console which is manufactured from the composite material.

3. The steering system according to claim 1, wherein the motor housing is manufactured from the composite material.

4. The steering system according to claim 1, wherein a stator assembly is attached in the motor housing by means of tolerance rings manufactured from composite material.

5. The steering system according to claim 1, wherein the steering column is attached to the console via brackets manufactured from composite material.

6. The steering system according to claim 1, wherein the upper steering shaft is arranged in a jacket tube manufactured from composite material.

7. The steering system according to claim 1, wherein the electric drive is a drive for an axially and/or vertically adjustable steering column.

8. The steering system according to claim 1, wherein the electric drive is a drive for a power steering system.

9. The steering system according to claim 1, wherein the electric drive is a drive for a superposition steering system.

10. The steering system according to claim 1, wherein the servo motor or the superposition drive is arranged on holders which are manufactured from composite material.
